(19) United States
(12) Patent Application Publication
(10) Pub. No.: US 2025/0026567 A1
(43) Pub. Date: Jan. 23, 2025

(54) Article Transport Facility

(71) Applicant: Daifuku Co., Ltd., Osaka-shi (JP)

(72) Inventors: Toru Konagaya, Hinocho (JP); Akira Takeuchi, Hinocho (JP)

(21) Appl. No.: 18/776,424

(22) Filed: Jul. 18, 2024

(30) Foreign Application Priority Data
Jul. 19, 2023 (JP) 2023-117788

(51) Int. Cl. B65G 1/04; B65G 1/06; B65G 1/137

(52) U.S. Cl. CPC B65G 1/0492; B65G 1/065; B65G 1/137

(57) ABSTRACT

An article transport facility includes a plurality of transport vehicles and a control system that controls the transport vehicles. The control system performs, in response to an abnormality in any of the plurality of transport vehicles, an abnormality process of setting a subarea likely to contain an abnormal transport vehicle having the abnormality as an entry prohibited area prohibiting entry of other normal transport vehicles.

### CROSS-REFERENCE TO RELATED APPLICATION

This application claims priority to Japanese Patent Application No. 2023-117788 filed Jul. 19, 2023, the disclosure of which is hereby incorporated by reference in its entirety.

### BACKGROUND OF THE INVENTION

### Field of the Invention

The present invention relates to an article transport facility.

### Description of Related Art

In distribution warehouses, for example, article transport facilities are used to transport articles. An example of such article transport facilities is described in Japanese Unexamined Patent Application Publication No. 2020-100482 (Patent Literature 1). The article transport facility (article transport facility F) in Patent Literature 1 includes multiple transport vehicles (article transport vehicles V) that transport articles (articles W) and a control system (integrated controller Cf) that controls the transport vehicles.

At the article transport facility in Patent Literature 1, the transport vehicles can travel vertically and horizontally on the floor (floor surface 70) and may thus collide with each other. Any collision can greatly reduce the transport efficiency. The article transport facility is to be prepared against collisions between the transport vehicles. Although the facility has any such preparation, a sudden event (e.g., an abnormality in one of the multiple transport vehicles) may trigger a collision. However, Patent Literature 1 describes no particular technique for avoiding collisions between the transport vehicles, particularly in response to a sudden event.
Patent Literature 1: Japanese Unexamined Patent Application Publication No. 2020-100482

### SUMMARY OF THE INVENTION

One or more aspects are directed to an article transport facility in which transport articles are appropriately transported while collisions between transport vehicles are avoided.

An article transport facility according to an aspect of the disclosure includes a plurality of transport vehicles that travel on a floor to transport articles, and a control system that controls the plurality of transport vehicles. The control system manages the floor by dividing the floor into a plurality of subareas each sized to accommodate a transport vehicle of the plurality of transport vehicles, controls each of the plurality of transport vehicles to travel from a subarea at a starting point among the plurality of subareas to a subarea at a destination point among the plurality of subareas through adjacent subareas of the plurality of subareas in sequence, performs a normal process of controlling the plurality of transport vehicles to cause not more than one transport vehicle of the plurality of transport vehicles to enter a same subarea of the plurality of subareas at a same time, and performs, in response to an abnormality in a transport vehicle of the plurality of transport vehicles, an abnormality process of setting a subarea likely to contain, among the plurality of subareas, an abnormal transport vehicle having the abnormality as an entry prohibited area prohibiting entry of other normal transport vehicles of the plurality of transport vehicles.

This structure allows articles to be appropriately transported by performing the normal process while avoiding collisions between the transport vehicles without any abnormality in any of the transport vehicles. In response to the abnormality in any of the transport vehicles, the abnormality process is performed to set the subarea likely to contain the abnormal transport vehicle as the entry prohibited area. This reduces the likelihood of a collision between the abnormal transport vehicle and another normal transport vehicle although the subarea containing the abnormal transport vehicle cannot be detected. Thus, the structure allows articles to be appropriately transported while avoiding collisions between the transport vehicles when any transport vehicle has an abnormality as well as when the transport vehicles are in the normal state.

Further features and advantageous effects of the technique according to one or more embodiments of the disclosure will be apparent from exemplary and nonlimiting embodiments described below with reference to the drawings.

### BRIEF DESCRIPTION OF THE DRAWINGS

FIG. 1 is a plan view of an article sorting facility including an article transport facility according to an embodiment.

FIG. 2 is a front view of an aisle area.

FIG. 3 is a block diagram of a control system.

FIG. 4 is a schematic diagram of an example travel path of a transport vehicle.

FIG. 5 is a schematic diagram describing an example normal process.

FIG. 6 is a schematic diagram describing another example normal process.

FIG. 7 is a schematic diagram describing an example first abnormality.

FIG. 8 is a schematic diagram describing an example abnormality process performed in response to the first abnormality.

FIG. 9 is a schematic diagram describing an example second abnormality.

FIG. 10 is a schematic diagram describing an example abnormality process performed in response to the second abnormality.

FIG. 11 is a schematic diagram describing an example third abnormality.

FIG. 12 is a schematic diagram describing an example abnormality process performed in response to the third abnormality.

FIG. 13 is a schematic diagram describing an example abnormality process.

### DESCRIPTION OF THE INVENTION

An article transport facility according to an embodiment will be described with reference to the drawings. An article transport facility 1 according to the present embodiment is used in, for example, a distribution center (e.g., an article sorting facility) to transport articles A to be removed from a warehouse and sorted for each delivery destination.

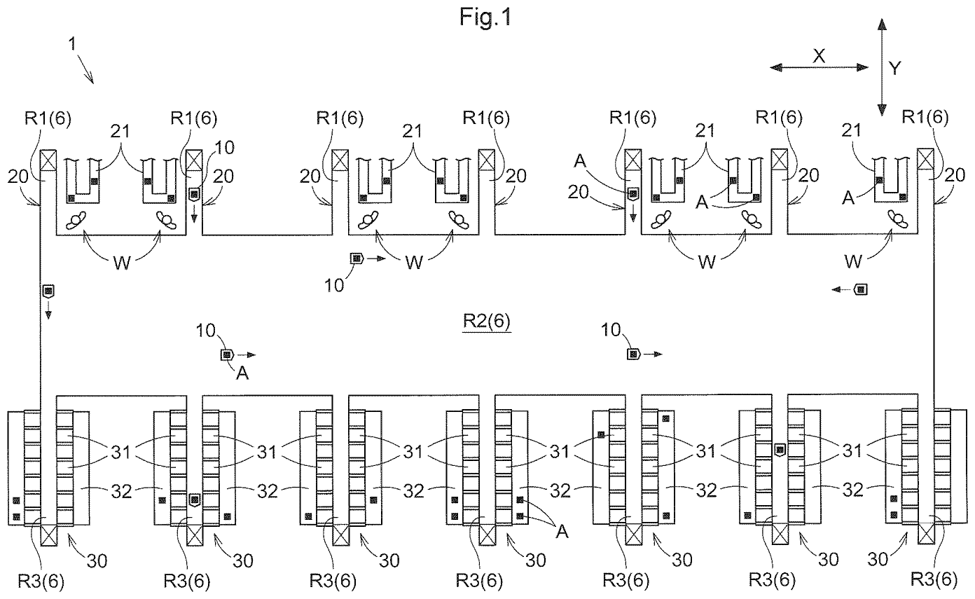

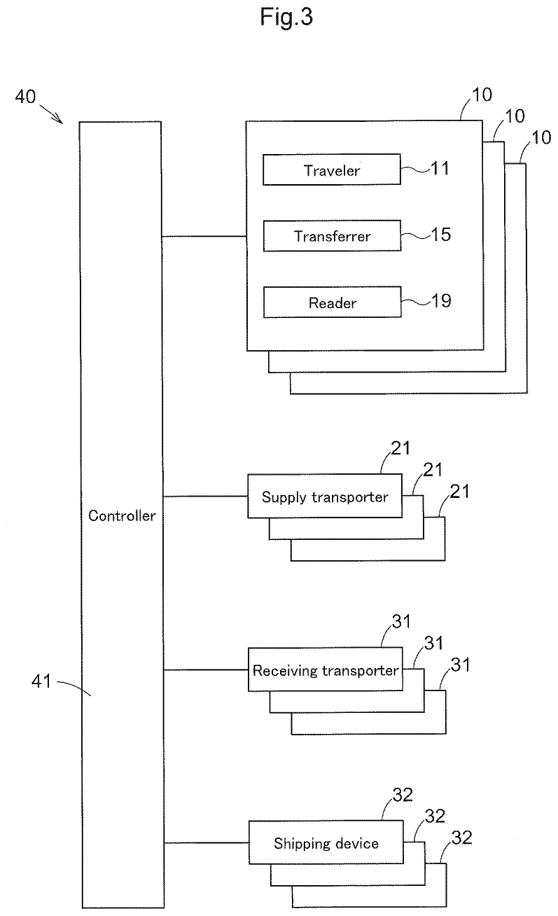

As shown in FIG. 1, the article transport facility 1 includes transport vehicles 10, supply units 20, and receivers 30. The article transport facility 1 further includes a control system 40 (refer to FIG. 3). The article transport facility 1 according to the present embodiment includes multiple transport vehicles 10, multiple supply units 20, multiple receivers 30, and a control system 40. The transport vehicles 10 travel on a floor 6 to transport the articles A. The supply units 20 supply the articles A to the transport vehicles 10. The receivers 30 receive the articles A from the transport vehicles 10. The control system 40 controls the multiple transport vehicles 10, the multiple supply units 20, and the multiple receivers 30.

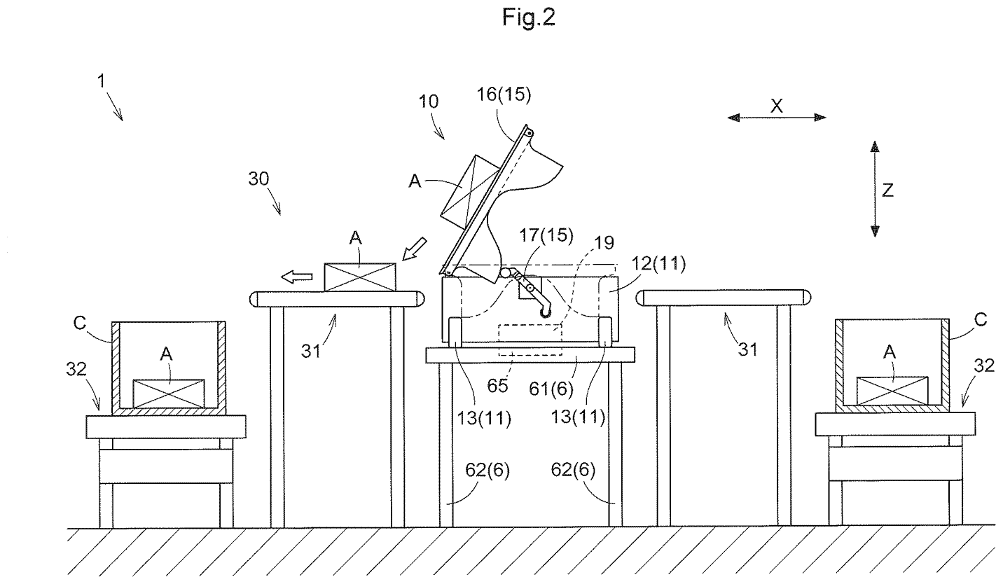

The floor 6 on which the transport vehicles 10 travel is a raised floor in the present embodiment, as shown in FIG. 2. The floor 6 includes a floor member 61 with an upper surface serving as a travel surface for the transport vehicles 10, and multiple pillars 62 that support the floor member 61 from below. The floor 6 has its upper surface (the upper surface of the floor member 61 in the present embodiment) flush with a horizontal plane. Position information holders 65 are disposed on the upper surface of the floor 6 (the upper surface of the floor member 61). Each position information holder 65 is, for example, a one-dimensional code (barcode), a two-dimensional code (e.g., quick response or QR code), or a radio-frequency identification tag. The position information holders 65 are disposed at multiple locations and each holds unique position information.

In the present embodiment, a specific direction along the floor 6 is referred to as an X-direction. A direction perpendicular to the X-direction and along the floor 6 is referred to as a Y-direction. In the present embodiment, the lateral direction in FIG. 1 is the specific direction defined as the X-direction, and the vertical direction in FIG. 1 perpendicular to the specific direction is defined as the Y-direction. The direction perpendicular to both the X-direction and the Y-direction (perpendicular to the page of FIG. 1) is defined as a Z-direction. The Z-direction is the vertical direction of the article transport facility 1 (refer to FIG. 2).

As shown in FIG. 1, the floor 6 has supply areas R1 with the supply units 20, a connection area R2, and aisle areas R3 with the receivers 30. In the present embodiment, the supply areas R1 and the aisle areas R3 are areas extending linearly in the Y-direction. The number of supply areas R1 is the same as the number of aisle areas R3. One supply area R1 and one aisle area R3 are aligned linearly in a pair in the X-direction, and several pairs of supply area R1 and aisle area R3 are intermittently arranged at intervals in the X-direction.

The connection area R2 connects the supply areas R1 and the aisle areas R3. In the present embodiment, the supply areas R1 and the aisle areas R3 are arranged at intervals in the Y-direction, and the connection area R2 connects the supply areas R1 and the aisle areas R3 in the Y-direction. The connection area R2 in the present embodiment is a rectangular area in a plan view extending in the X-direction and the Y-direction to connect all the supply areas R1 and all the aisle areas R3 in the Y-direction.

As described above, the floor 6 has the rectangular connection area R2 disposed in the middle in the Y-direction. The multiple supply areas R1 are arranged in intermittently in the X-direction and extend in the Y-direction from the connection area R2 on one side (the upper end in FIG. 1) of the floor 6 in the Y-direction. The multiple aisle areas R3 are aligned with the respective supply areas R1 and extend in the Y-direction from the connection area R2 on the other side (the lower end in FIG. 1) of the floor 6 in the Y-direction.

Each transport vehicle 10 that travels on the floor 6 includes a traveler 11 and a transferrer 15 as shown in FIG. 2. The traveler 11 includes a body 12 and wheels 13 supported on a lower portion of the body 12 in a rotatable manner. The wheels 13 roll on the travel surface on the floor 6. The multiple wheels 13 include at least one wheel 13 as a drive wheel to which a drive force from a drive source (e.g., a drive motor or an internal combustion engine) is transmitted. The transport vehicle 10 in the present embodiment is an electric vehicle including a drive motor as a drive source, and travels with electric power supplied from, for example, a battery or a fuel cell or through contact or contactless power supply from the floor 6.

The transferrer 15 includes a mount 16 supported above the body 12 and a drive 17. The mount 16 is switchable between a horizontal orientation in the horizontal direction and a tilting orientation tilting with respect to the horizontal direction. In the present embodiment, the mount 16 in the tilting orientation is switchable between a first tilting orientation tilting about one end in the X-direction as a rotation axis, while facing in the Y-direction, and a second tilting orientation tilting about the other end in the X-direction as a rotation axis. In other words, the mount 16 is switchable between the horizontal orientation, the first tilting orientation, and the second tilting orientation. The drive 17 drives the mount 16 to switch between the horizontal orientation and the tilting orientation (the first tilting orientation or the second tilting orientation). The drive 17 may be, for example, a drive with a bar mechanism, a cylinder mechanism, or a ball screw mechanism.

Each transport vehicle 10 also includes a reader 19 for reading information held by the position information holders 65 on the upper surface of the floor 6. The reader 19 is used as appropriate for the type of the position information holders 65. The reader 19 is, for example, a barcode reader, a QR code reader, or a radio-frequency identification tag reader. The transport vehicle 10 may include a speed sensor to detect travel speed and an acceleration sensor to detect acceleration.

The multiple supply units 20 spaced from one another in the X-direction each include a supply transporter 21. In the present embodiment, one supply transporter 21 is disposed in each supply area R1. The supply transporter 21 is in a loop with an outgoing path and a return path to transport articles A from an automated warehouse (not shown) and transport articles A to the automated warehouse. The supply transporter 21 may be, for example, a conveyor or an automated transport vehicle, or may be a combination of multiple types.

In the present embodiment, articles A are supplied to transport vehicles 10 by an operating entity W transferring the articles A to the transport vehicles 10 at each supply unit 20. In other words, the operating entity W transfers articles A transported from the automated warehouse by the supply transporter 21 to transport vehicles 10 at the supply unit 20. The operating entity W may be, for example, an operator or an operation device (e.g., a robotic arm), or may be a combination of multiple types. Each transport vehicle 10 receives an article A on the mount 16 in the horizontal orientation and travels toward a receiver 30 with the article A on the mount 16.

The multiple receivers 30 spaced from one another in the X-direction each include receiving transporters 31 and shipping devices 32. In the present embodiment, as shown in FIGS. 1 and 2, the receiving transporters 31 and the shipping devices 32 are arranged in each aisle area R3. Each aisle area R3 includes multiple (seven in this example) receiving transporters 31 on each side of the aisle area R3 in the X-direction. The receiving transporters 31 are arranged in the Y-direction on each side. Each aisle area R3 includes one shipping device 32 on each side of the aisle area R3 in the X-direction with the receiving transporters 31 between the aisle area R3 and the shipping device 32. The shipping device 32 extends in the Y-direction on each side. Each receiving transporter 31 may be, for example, a conveyor, a crane, or a robotic arm, or may be a combination of multiple types. Each shipping device 32 may be, for example, a conveyor or an automated transport vehicle, or may be a combination of multiple types.

In the present embodiment, the mount 16 in the transport vehicle 10 switches to the tilting orientation (the first tilting orientation or the second tilting orientation) in the receiver 30. The article A is transferred from the transport vehicle 10 to a receiving transporter 31, and then to the corresponding shipping device 32 from the receiving transporter 31 (refer to FIG. 2). The mount 16 in the first tilting orientation transfers the article A to one shipping device 32 through the corresponding receiving transporter 31 on one end in the X-direction. The mount 16 in the second tilting orientation transfers the article A to another shipping device 32 through the corresponding receiving transporter 31 on the other end in the X-direction.

Each receiving transporter 31 has a transport surface at a level lower than or equal to the level of the mount 16 in each transport vehicle 10 on the floor 6. A container C is disposed on each shipping device 32. The difference between the level of the transport surface of the receiving transporter 31 and the level of the transport surface of the shipping device 32 is set to be greater than or equal to the height of the container C. An article A transferred from the transport vehicle 10 is placed into the container C on the shipping device 32 through the receiving transporter 31.

One container C has one delivery destination, and the type and the number of articles A specified in one set of order information are sequentially placed into the container C corresponding to the order information. When all the articles A specified in the order information are placed in the container C, the container C filled with the articles A is transported by the shipping device 32.

The transport vehicle 10 returns to the supply area R1 along a returning path after transferring the article A in the aisle area R3. The returning path may be on the floor 6 or may extend on a level different from the level of the floor 6 in the Z-direction. For the transport vehicle 10 powered with a battery, a charging station may be disposed on the returning path.

As shown FIG. 3, the control system 40 includes a controller 41 that controls the transport vehicles 10 (the travelers 11 and the transferrers 15). The control system 40 (the controller 41) controls the supply transporters 21, the receiving transporters 31, and the shipping devices 32, in addition to the transport vehicles 10. The controller 41 includes an arithmetic processor such as a central processing unit (CPU) and a main storage such as a random-access memory (RAM) or a read-only memory (ROM). The functions of the controller 41 are implemented by the arithmetic processor and a program executable on the arithmetic processor cooperating with each other.

The controller 41 may be a set of multiple pieces of hardware (multiple separate pieces of hardware) that can communicate with one another through wires or wirelessly, rather than a single piece of hardware. For example, the controller 41 may include a host controller installed in a control facility (not shown) and control terminals mounted on a different transport vehicle 10 to communicate with the host controller.

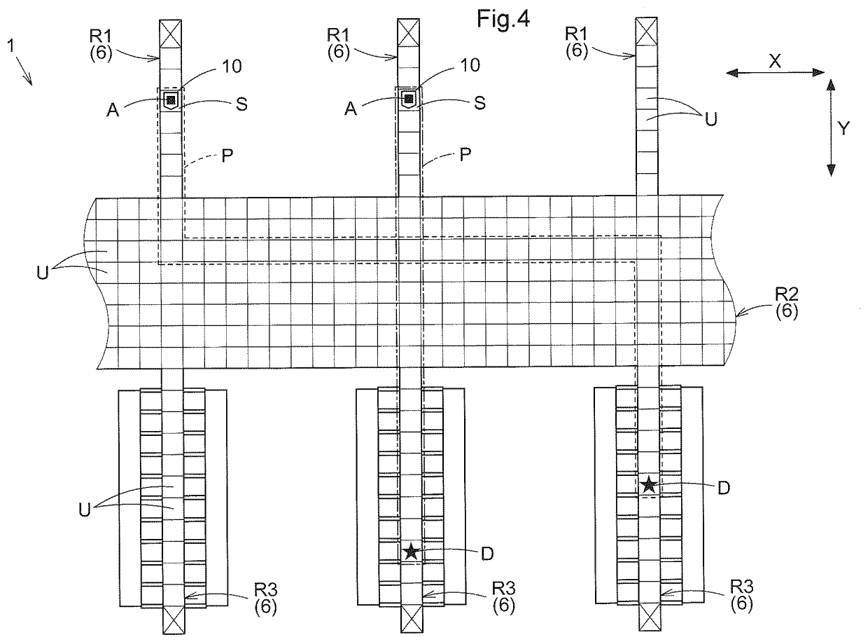

As shown in FIG. 4, the control system 40 manages the floor 6 by dividing the floor into multiple subareas U each sized to accommodate the transport vehicle 10 when viewed in the Z-direction. As described above, the floor 6 in the present embodiment has the multiple supply areas R1 extending linearly in the Y-direction, the rectangular connection area R2 extending in the X-direction and the Y-direction, and the multiple aisle areas R3 extending linearly in the Y-direction. The supply area R1 and the aisle area R3 are managed using multiple subareas U aligned linearly in the Y-direction. The connection area R2 is managed using multiple subareas U arranged in a grid (an orthogonal grid) in the X-direction and the Y-direction. Each subarea U includes the position information holder 65 that holds unique position information. The control system 40 controls each of the multiple transport vehicles 10 based on the information obtained from the position information holder 65.

The control system 40 controls each of the transport vehicles 10 to travel from a subarea U at a starting point S to a subarea U at a destination point D through adjacent subareas U in sequence. The starting point S corresponds to a point at which a target transport vehicle 10 receives an article A from the supply transporter 21 in any of the supply areas R1. The destination point D corresponds to a point in the aisle area R3 adjacent in the X-direction to the container C to which the transport vehicle 10 receiving the article A is to deliver the article A. The receiving transporter 31 is disposed between the point in the aisle area R3 and the container C.

As shown in FIG. 4, when the starting point S and the destination point D are aligned with each other in the X-direction, a travel path P of the transport vehicle 10 is a set of a subarea U at the starting point S, a subarea U at the destination point D, and multiple subareas U aligned linearly in the Y-direction between these subareas U.

In contrast, when the starting point S and the destination point D are not aligned with each other in the X-direction, a travel path P of the transport vehicle 10 is a set of a subarea U at the starting point S, a subarea U at a first turning point, a subarea U at a second turning point that is aligned with the first turning point in the Y-direction and with the destination point D in the X-direction, a subarea U at the destination point D, and multiple subareas U aligned linearly between these subareas U in the X-direction or in the Y-direction.

The control system 40 performs a normal process and an abnormality process in controlling the multiple transport vehicles 10. The normal process is performed when no transport vehicle 10 has an abnormality. The abnormality process is performed in response to an abnormality in any of the multiple transport vehicles 10. The normal process is performed on the transport vehicles 10 traveling in all the areas of the supply area R1, the connection area R2, and the aisle area R3. The abnormality process is mainly performed on the transport vehicles 10 traveling in the connection area R2 that is rectangular in a plan view and extends in the X-direction and the Y-direction.

The control system 40 determines whether an individual transport vehicle 10 has an abnormality based on information obtained from each of the multiple transport vehicles 10. The control system 40 determines whether the transport vehicle 10 travels along the travel path P as scheduled or stops correctly at a predetermined position based on the position information read by, for example, the reader 19 in the transport vehicle 10. In this case, when the control system 40 determines that the transport vehicle 10 deviates from the scheduled travel path P or from the scheduled stop position, the control system 40 detects an abnormality in the transport vehicle 10.

The control system 40 determines whether the transport vehicle 10 travels smoothly without any sudden deceleration based on acceleration information obtained by an acceleration sensor in the transport vehicle 10. In this case, when the control system 40 detects a negative acceleration exceeding a predetermined value preset with a reference using an absolute value, the control system 40 detects an abnormality in the transport vehicle 10.

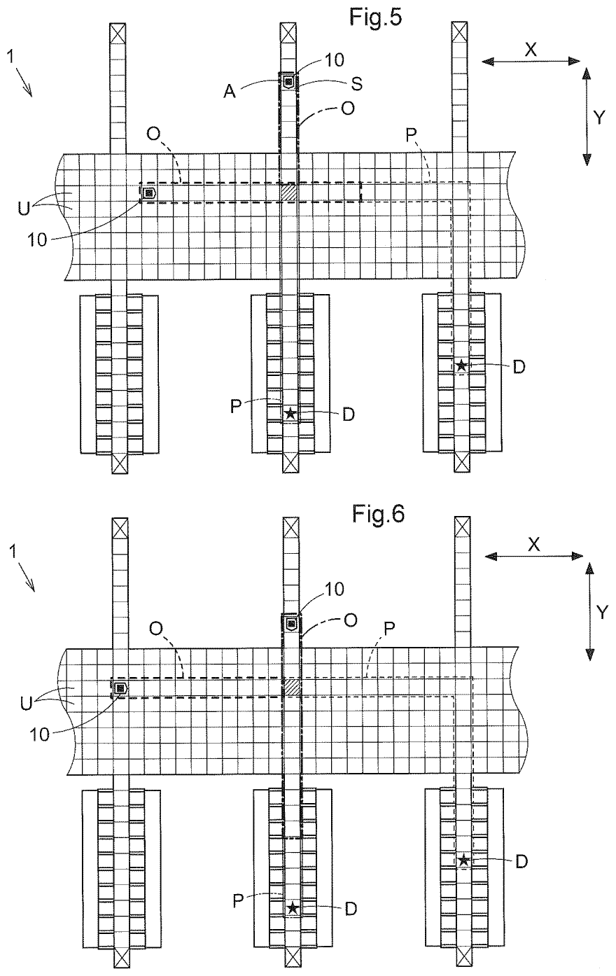

In the normal process performed when no transport vehicle 10 has an abnormality, the control system 40 controls the multiple transport vehicles 10 to cause not more than one transport vehicle 10 to enter the same subarea U at the same time. Before performing the normal process, the control system 40 sets a preoccupied number of subareas U in the forward direction along the travel path P from the current position of each transport vehicle 10 to the destination point D as an occupied area O of the transport vehicle 10 (refer to FIGS. 5 and 6). The occupied area O can be referred to as an area being preoccupied (a preoccupied area) in which no other transport vehicles 10 are allowed to enter, thus allowing the target transport vehicle 10 to travel. The occupied area O also includes the current position of the target transport vehicle 10. When the transport vehicle 10 moves, the occupied area O starting from the current position also moves accordingly.

The preoccupied number specifying the size of the occupied area O may be a uniform fixed value or a variable value varied based on the conditions of the transport vehicles 10. The preoccupied number can be determined by the user as appropriate to increase an overall transport efficiency of the article transport facility 1.

When the occupied areas O intersect between different transport vehicles 10 in the normal process (the subarea U at the intersection is herein referred to as an overlapping area), the control system 40 in the present embodiment prioritizes the transport vehicle 10 that first sets the overlapping area as the occupied area O to travel. In the example shown in FIG. 5, the transport vehicle 10 traveling in the X-direction, before the transport vehicle 10 that is ready to start traveling in the Y-direction, first sets the overlapping area hatched with diagonal lines in the figure as the occupied area O. Thus, the control system 40 prioritizes the transport vehicle 10 traveling in the X-direction to travel in the occupied area O of the transport vehicle 10.

In the example shown in FIG. 6, the transport vehicle 10 traveling in the Y-direction, before the transport vehicle 10 that is ready to start traveling in the X-direction, first sets the overlapping area hatched with diagonal lines in the figure as the occupied area O. Thus, the control system 40 prioritizes the transport vehicle 10 traveling in the Y-direction to travel in the occupied area O of the transport vehicle 10.

Thus, the control system 40 controls the multiple transport vehicles 10 to cause not more than one transport vehicle 10 to enter the same subarea U at the same time by prioritizing the transport vehicle 10 that has first set the overlapping area as the occupied area O to travel in the normal process. This allows appropriate transport of the article A while avoiding collisions between the transport vehicles 10.

Although the normal process is performed to avoid more than one transport vehicle 10 entering the same subarea U at the same time, a collision may still occur in response to an abnormality in any of the multiple transport vehicles 10. In the present embodiment, in the abnormality process performed in response to an abnormality in any of the multiple transport vehicles 10, the control system 40 sets the subarea U likely to contain the transport vehicle 10 having the abnormality (hereafter referred to as an abnormal transport vehicle 10E) as an entry prohibited area K prohibiting the entry of other normal transport vehicles 10.

As described above, each subarea U includes the position information holder 65 that holds unique position information, and each transport vehicle 10 includes the reader 19 for reading the information held by the position information holder 65. The control system 40 may thus determine one subarea U containing the abnormal transport vehicle 10E, or multiple subareas U containing the abnormal transport vehicle 10E across the boundaries based on the position information read by each transport vehicle 10 with the reader 19. In such a case, the control system 40 sets, as the entry prohibited area K, the entire part of at least one subarea U detected to contain the abnormal transport vehicle 10E.

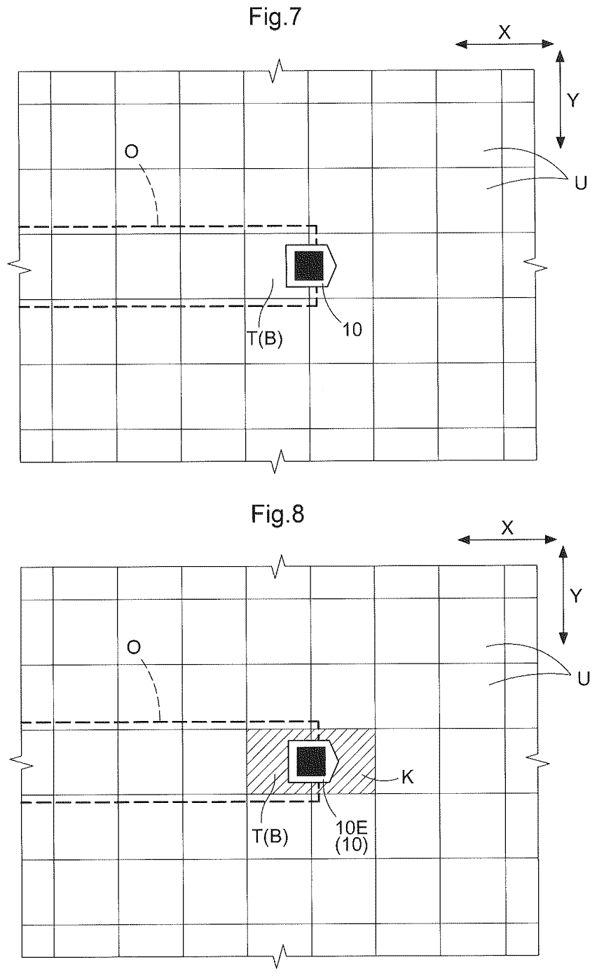

For example, as shown in FIG. 7, the transport vehicle 10 may deviate from the subarea U at which the transport vehicle 10 is scheduled to stop (hereafter referred to as a stop target position T) within a range in which the position information holder 65 in the stop target position T is readable by the transport vehicle 10. This refers to an overrun. In such a case, the transport vehicle 10 can read the position information holder 65, thus determining one subarea U containing the transport vehicle 10, or multiple subareas U across the boundaries. In the present embodiment, such an abnormality is referred to as a first abnormality.

In response to the first abnormality in the abnormal transport vehicle 10E, as shown in FIG. 8, the control system 40 sets, as the entry prohibited area K, the range of L subareas U in the forward traveling direction of the abnormal transport vehicle 10E starting from the subarea U containing the abnormal transport vehicle 10E immediately before having the abnormality (more specifically, the subarea U containing the abnormal transport vehicle 10E lastly reading the position information holder 65; hereafter referred to as an immediately preceding area B, or the stop target position T in this case), where L is an integer greater than or equal to 2. In the present embodiment, the control system 40 sets the two subareas U containing the abnormal transport vehicle 10E across the boundary due to an overrun as the entry prohibited area K. In this case, L is 2.

In contrast, the control system 40 may not determine one subarea U containing the abnormal transport vehicle 10E, or multiple subareas U containing the abnormal transport vehicle 10E across the boundaries when each transport vehicle 10 cannot read the position information with the reader 19. In such a case, the control system 40 sets a different range of entry prohibited area K based on the type of the abnormality in the abnormal transport vehicle 10E.

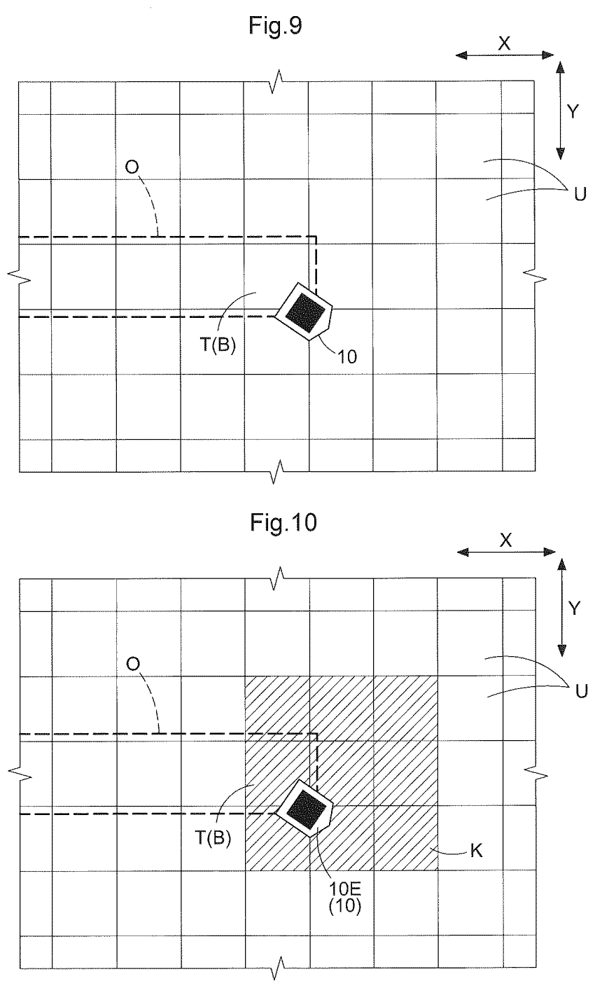

As shown in FIG. 9, for example, the transport vehicle 10 may deviate from the stop target position T by a degree to which the position information holder 65 at the stop target position Tis unreadable by the transport vehicle 10. This refers to deviation. In such a case, the transport vehicle 10 cannot read the position information holder 65, and thus cannot determine one subarea U containing the transport vehicle 10, or multiple subareas U across the boundaries. In the present embodiment, such an abnormality is referred to as a second abnormality.

In response to the second abnormality in the abnormal transport vehicle 10E, as shown in FIG. 10, the control system 40 sets, as the entry prohibited area K, a range of M×M subareas U in the forward traveling direction including the immediately preceding area B (the stop target position T in this example), where M is an integer greater than or equal to 2. For the second abnormality (deviation), the abnormal transport vehicle 10E may deviate more in the forward traveling direction than for the first abnormality (overrun), or may shift laterally relative to the traveling direction. The control system 40 thus sets the range of M×M subareas U including the immediately preceding area B (stop target position T) and a slight margin in the forward traveling direction from the immediately preceding area B (stop target position T) as the entry prohibited area K.

As shown in FIG. 11, for example, the transport vehicle 10 may collide with another transport vehicle 10. In the present embodiment, an abnormality caused by the transport vehicle 10 colliding with another transport vehicle 10 is referred to as a third abnormality.

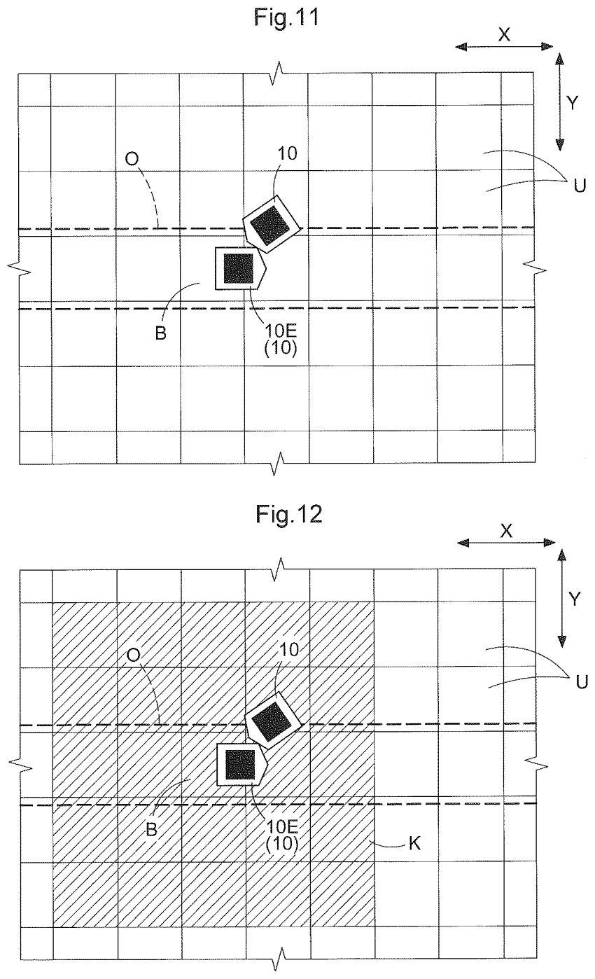

In response to the third abnormality in the abnormal transport vehicle 10E, as shown in FIG. 12, the control system 40 sets a range of N×N subareas U centered at the immediately preceding area B as the entry prohibited area K, where N is an integer greater than M. For the third abnormality (collision), the transport vehicle 10E deviates in the direction or shifts by the distance varying based on the degree of the collision. The control system 40 thus sets the range of N×N subareas U including a certain amount of margin centered at the immediately preceding area B as the entry prohibited area K.

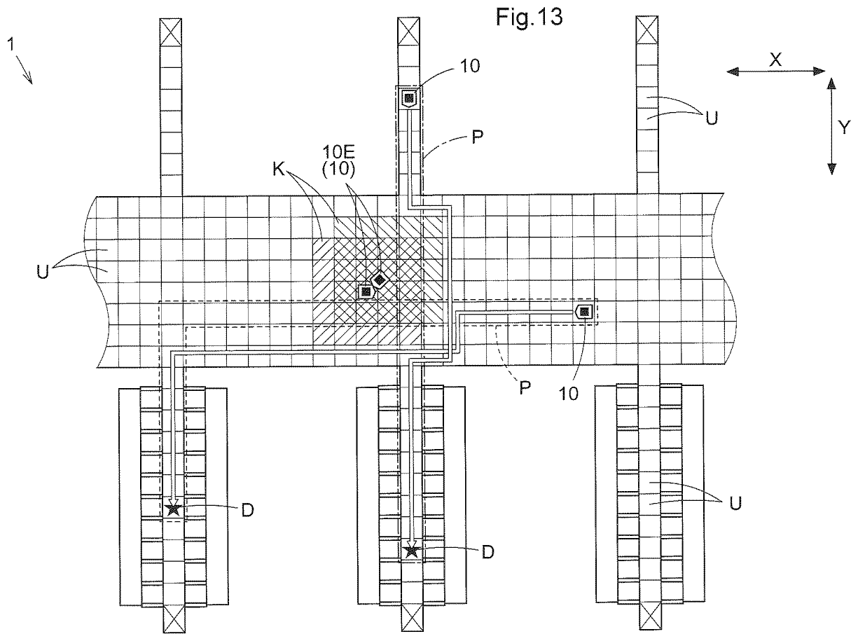

For clarity, FIG. 12 shows one transport vehicle 10 that has collided as an abnormal transport vehicle 10E and its entry prohibited area K. However, the other transport vehicle 10 that has collided is also an abnormal transport vehicle 10E, and the range of N×N subareas U centered at the other abnormal transport vehicle 10E is also set as the entry prohibited area K (refer to FIG. 13). In multiple collisions, still more transport vehicles 10 may be abnormal transport vehicles 10E. Thus, when viewed as a whole, the union of sets of the ranges of N×N subareas U centered at the immediately preceding area B of all the transport vehicles 10 that have collided is set as the entry prohibited area K.

As described above, in the present embodiment, the control system 40 distinguishes and identifies three types of abnormalities that may occur in the transport vehicle 10, or specifically, the first abnormality, the second abnormality, and the third abnormality. In response to the first abnormality in the abnormal transport vehicle 10E, the control system 40 sets a range of L subareas U in the forward traveling direction of the abnormal transport vehicle 10E starting from the immediately preceding area B (the stop target position T in this example) as the entry prohibited area K. In response to the second abnormality in the abnormal transport vehicle 10E, the control system 40 sets a range of M×M subareas U in the forward traveling direction including the immediately preceding area B (the stop target position T in this example) as the entry prohibited area K. In response to the third abnormality in the abnormal transport vehicle 10E, the control system 40 sets a range of N× N subareas U centered at the immediately preceding area B as the entry prohibited area K.

The value L defining the size of the entry prohibited area K for the first abnormality is an integer greater than or equal to 2. For the first abnormality, the abnormal transport vehicle 10E can read the position information holder 65 and determine the two subareas U across the boundary. Thus, the value L may be 2. This allows the entry prohibited area K to be minimized based on the determined position of the abnormal transport vehicle 10E having the first abnormality (overrun). This can avoid a collision between the abnormal transport vehicle 10E and another normal transport vehicle 10 while minimizing the impact on the other normal transport vehicle 10.

The value M defining the size of the entry prohibited area K for the second abnormality is an integer greater than or equal to 2. To avoid the entry prohibited area K being too large, the value M may be less than or equal to 5. Additionally, the entry prohibited area K may include one row starting from the immediately preceding area B and also includes an equal number of rows on each side. Thus, the value M may be an odd number. Based on all these, the value M may be 3. When the position of the abnormal transport vehicle 10E having the second abnormality (deviation) cannot be determined, this can appropriately avoid a collision between the abnormal transport vehicle 10E and another normal transport vehicle 10 while minimizing the entry prohibited area K.

The value N defining the size of the entry prohibited area K for the third abnormality is an integer greater than M. Although the abnormal transport vehicle 10E may move greatly due to a collision, the value may be less than or equal to 8 to avoid the entry prohibited area K being too large. Additionally, the entry prohibited area K may extend in the equal number in each direction from the immediately preceding area B as the center. Thus, the value N may be an odd number. Based on these and such values of M as the reference, the value N may be less than or equal to 7, or more specifically, may be 5. When the position of the abnormal transport vehicle 10E having the third abnormality (collision) cannot be determined, this can appropriately avoid a secondary collision between the abnormal transport vehicle 10E and another normal transport vehicle 10.

When the abnormal transport vehicle 10E is stopped and the entry prohibited area K is set, and when a travel path P of another transport vehicle 10 overlaps the entry prohibited area K, the control system 40 controls the other transport vehicle 10 to bypass the entry prohibited area K, as shown in FIG. 13. In this case, for each of the transport vehicles 10 with the travel path P being changed, the control system 40 may reroute the travel path P to minimize the travel path length and to reduce the number of turning points. When the occupied area O in the rerouted travel path P of each of the transport vehicles 10 intersects, the control system 40 prioritizes the transport vehicle 10 that first sets the overlapping area to the occupied area O to travel, as described in the normal process. The control system 40 also removes the entry prohibited area K when the abnormal transport vehicle 10E resumes traveling.

The abnormality process described above allows setting of the entry prohibited area K in response to an abnormality in any of the multiple transport vehicles 10. This allows the articles A to be transferred appropriately while avoiding a collision between the transport vehicles 10 in response to a sudden abnormality in any transport vehicle 10. The technique described in the present embodiment is particularly suitable for a structure in which each transport vehicle 10 in the article transport facility 1 does not include a collision avoidance sensor.

### Other Embodiments

(1) In the structure mainly described in the above embodiment, the preoccupied number for setting the occupied area O in the normal process is a fixed value. However, the disclosure is not limited to such a structure. The preoccupied number for setting the occupied area O may be a variable value based on the state of the transport vehicle 10. For example, the preoccupied number (first preoccupied number) when the traveling direction of the transport vehicle 10 is the Y-direction may be greater than the preoccupied number (second preoccupied number) when the traveling direction of the transport vehicle 10 is the X-direction. When the travel path P of the transport vehicle 10 includes a turning point, the preoccupied number may be set as a number that gradually decreases as the transport vehicle 10 moves from the current position to the turning point.

(2) In the above embodiment, an overrun is an example of the first abnormality. In this example, two subarea U starting from the immediately preceding area B (stop target position T) is set as the entry prohibited area K when the abnormality in the abnormal transport vehicle 10E is the first abnormality. However, the disclosure is not limited to such a structure. The abnormal transport vehicle 10E in the first abnormality may be within one subarea U. In such a case, the control system 40 sets one subarea corresponding to the immediately preceding area B (stop target position T) alone as the entry prohibited area K.

(3) In the above embodiment, deviation is an example of the second abnormality. For deviation, the structure described in the above embodiment cannot detect the multiple subareas U containing the abnormal transport vehicle 10E across the boundaries. However, the disclosure is not limited to such a structure. When the multiple subareas U containing the abnormal transport vehicle 10E across the boundaries can be detected in response to deviation, the control system 40 may set all (two or four) subareas U detected to contain the abnormal transport vehicle 10E as the entry prohibited area K.

(4) In the above embodiment, the entry prohibited area K that is set in response to the second abnormality in the abnormal transport vehicle 10E is the range of M×M subareas U in the forward traveling direction with respect to the immediately preceding area B. However, the disclosure is not limited to such a structure. For example, the range of M×M subareas U centered at the immediately preceding area B may be set as the entry prohibited area K. The entry prohibited area K may be other than a square, and may be a rectangular range including, for example, M×(M+1) or M×(M+2) subareas U. In another example, the entry prohibited area K may be a range with other shapes such as a triangular or a trapezoidal shape.

(5) In the above embodiment, the entry prohibited area K that is set in response to the third abnormality in the abnormal transport vehicle 10E is the range of N×N subareas U centered at the immediately preceding area B. However, the disclosure is not limited to such a structure. For example, a range of N×N subareas U in the forward traveling direction with respect to the immediately preceding area B may be set as the entry prohibited area K. The entry prohibited area K may be other than a square, and may be a rectangular range including, for example, N× (N+1) or N×(N+2) subareas U. In another example, the entry prohibited area K may be a range with other shapes such as a circular or an oval shape.

(6) In the above embodiment, each subarea U includes the position information holder 65, and each transport vehicle 10 includes the reader 19 for reading the information held by the position information holder 65. The control system 40 controls multiple transport vehicles 10 based on information obtained from the position information holders 65. However, the disclosure is not limited to such a structure. For example, sensors and cameras are installed in the individual transport vehicles 10 or at the facility, and the control system 40 may control multiple transport vehicles 10 based on the information obtained from these sensors and cameras.

(7) In the structure mainly described in the above embodiment, the supply areas R1, the connection area R2, and the aisle areas R3 represent areas divided by the physical outer edge of the floor 6. However, the disclosure is not limited to such a structure. The supply areas R1, the connection area R2, and the aisle areas R3 may be virtual areas that are simply defined on the floor 6.

(8) In the above embodiment, the supply areas R1 and the aisle areas R3 extend linearly in the Y-direction, and the connection area R2 is a rectangular area in a plan view extending in the X-direction and the Y-direction. However, the disclosure is not limited to such a structure. For example, at least one of the supply areas R1 or the aisle areas R3 may be a rectangular area in a plan view extending in the X-direction and the Y-direction, or the supply areas R1, the connection area R2, and the aisle areas R3 may be entirely a rectangular area in a plan view extending in the X-direction and the Y-direction. In these cases, the abnormality process may be performed in a rectangular area in a plan view (the supply areas R1+ the connection area R2, the connection area R2+ the aisle areas R3, or the supply areas R1+ the connection area R2+ the aisle areas R3) extending in the X-direction and the Y-direction.

(9) In the above embodiment, the controller 41 in the control system 40 includes a host controller and control terminals each mounted on a different transport vehicle 10 to communicate with the host controller. However, the disclosure is not limited to such a structure. For example, the control system 40 may be a system in which the control terminals on the respective transport vehicles 10 communicate with one another to autonomously determine the operation. In this case, the control terminals on the respective transport vehicles 10 communicate with one another to perform the normal process and the abnormality process.

(10) The structure mainly described in the above embodiment, each transport vehicle 10 does not include a collision avoidance sensor. However, the disclosure is not limited to such a structure. The technique according to one or more embodiments of the disclosure is readily applicable to an article transport facility 1 including multiple transport vehicles 10 with collision avoidance sensors.

(11) The structure described in each of the above embodiments (including the above embodiments and other embodiments; the same applies hereafter) may be combined with any other structures described in the other embodiments unless any contradiction arises. The embodiments described herein are merely illustrative in all respects for other structures as well and may be modified as appropriate without departing from the spirit and scope of the disclosure.

### Overview of Embodiment

The article transport facility according to one or more embodiments of the disclosure may have the structure described below.

An article transport facility includes a plurality of transport vehicles that travel on a floor to transport articles, and a control system that controls the plurality of transport vehicles. The control system manages the floor by dividing the floor into a plurality of subareas each sized to accommodate a transport vehicle of the plurality of transport vehicles, controls each of the plurality of transport vehicles to travel from a subarea at a starting point among the plurality of subareas to a subarea at a destination point among the plurality of subareas through adjacent subareas of the plurality of subareas in sequence, performs a normal process of controlling the plurality of transport vehicles to cause not more than one transport vehicle of the plurality of transport vehicles to enter a same subarea of the plurality of subareas at a same time, and performs, in response to an abnormality in a transport vehicle of the plurality of transport vehicles, an abnormality process of setting a subarea likely to contain, among the plurality of subareas, an abnormal transport vehicle having the abnormality as an entry prohibited area prohibiting entry of other normal transport vehicles of the plurality of transport vehicles.

This structure allows articles to be appropriately transported by performing the normal process while avoiding collisions between the transport vehicles without any abnormality in any of the transport vehicles. In response to the abnormality in any of the transport vehicles, the abnormality process is performed to set the subarea likely to contain the abnormal transport vehicle as the entry prohibited area. This reduces the likelihood of a collision between the abnormal transport vehicle and another normal transport vehicle although the subarea containing the abnormal transport vehicle cannot be detected. Thus, the structure allows articles to be appropriately transported while avoiding collisions between the transport vehicles when any transport vehicle has an abnormality as well as when the transport vehicles are in the normal state.

In one aspect, in the abnormality process, in response to the control system detecting, among the plurality of subareas, one subarea containing the abnormal transport vehicle or a plurality of subareas containing the abnormal transport vehicle across a boundary between the plurality of subareas, the control system may set, as the entry prohibited area, a full area of at least one subarea detected to contain the abnormal transport vehicle.

In this structure, in response to one or more subareas containing an abnormal transport vehicle being detected, the entry prohibited area can be set to a minimum range based on detection result. This minimizes the impact on the travel of other normal transport vehicles in response to an abnormality in any of the transport vehicles.

In one aspect, in the abnormality process, in response to the control system not detecting, among the plurality of subareas, one subarea containing the abnormal transport vehicle or a plurality of subareas containing the abnormal transport vehicle across a boundary between the plurality of subareas, the control system may set a different range of the entry prohibited area based on a type of the abnormality in the abnormal transport vehicle.

This structure allows, when one or more subareas containing the abnormal transport vehicle is not detected, the entry prohibited area to be easily set to an appropriate size based on the type of the abnormality in the abnormal transport vehicle. Thus, the structure appropriately reduces, based on the type of the abnormality in the abnormal transport vehicle, the likelihood of a collision between the abnormal transport vehicle and other normal transport vehicles, while minimizing the impact on the travel of other normal transport vehicles.

More specifically, each of the plurality of subareas may include a position information holder holding position information of the subarea. Each of the plurality of transport vehicles may include a reader that reads the position information held by the position information holder. The abnormality in the transport vehicle may include a first abnormality caused by the transport vehicle deviating from a stop target position within a range in which the position information holder at the stop target position is readable by the transport vehicle, a second abnormality caused by the transport vehicle deviating from the stop target position by a degree to which the position information holder at the stop target position is unreadable by the transport vehicle, and a third abnormality caused by the transport vehicle colliding with another transport vehicle of the plurality of transport vehicles. In response to the first abnormality in the abnormal transport vehicle, the control system may set, as the entry prohibited area, a range of L subareas in a forward traveling direction of the abnormal transport vehicle starting from, among the plurality of subareas, a subarea containing the abnormal transport vehicle immediately before having the abnormality, where L is an integer greater than or equal to 2. In response to the second abnormality in the abnormal transport vehicle, the control system may set, as the entry prohibited area, a range of M×M subareas in the forward traveling direction of the abnormal transport vehicle including the subarea containing the abnormal transport vehicle immediately before having the abnormality, where M is an integer greater than or equal to 2. In response to the third abnormality in the abnormal transport vehicle, the control system may set, as the entry prohibited area, a range of N×N subareas centered at the subarea containing the abnormal transport vehicle immediately before having the abnormality, where N is an integer greater than M.

In this structure, a reference position for setting the entry prohibited area is appropriately determined based on the type of the abnormality, and a range of the entry prohibited area is wider for a greater degree of the abnormality. This allows the range of the entry prohibited area to be set appropriately based on whether the abnormality in the abnormal transport vehicle is the first abnormality, the second abnormality, or the third abnormality. Thus, the structure appropriately reduces, based on whether the abnormality in the abnormal transport vehicle is the first abnormality, the second abnormal, or the third abnormality, the likelihood of a collision between the abnormal transport vehicle and other normal transport vehicles, while minimizing the impact on the travel of other normal transport vehicles.

The article transport facility according to one or more embodiments of the disclosure produces at least one of the effects described above.

What is claimed is:

1. An article transport facility, comprising:
a plurality of transport vehicles configured to travel on a floor to transport articles; and
a control system configured to control the plurality of transport vehicles, and
wherein the control system configured to:
manage the floor by dividing the floor into a plurality of subareas each sized to accommodate a transport vehicle of the plurality of transport vehicles,
control each of the plurality of transport vehicles to travel from a subarea at a starting point among the plurality of subareas to a subarea at a destination point among the plurality of subareas through adjacent subareas of the plurality of subareas in sequence,
perform a normal process of controlling the plurality of transport vehicles to cause not more than one transport vehicle of the plurality of transport vehicles to enter a same subarea of the plurality of subareas at a same time, and
perform, in response to an abnormality in a transport vehicle of the plurality of transport vehicles, an abnormality process of setting a subarea likely to contain, among the plurality of subareas, an abnormal transport vehicle having the abnormality as an entry prohibited area prohibiting entry of other normal transport vehicles of the plurality of transport vehicles.

2. The article transport facility according to claim 1, wherein:
in the abnormality process, in response to the control system detecting, among the plurality of subareas, one subarea containing the abnormal transport vehicle or a plurality of subareas containing the abnormal transport vehicle across a boundary between the plurality of subareas, the control system sets, as the entry prohibited area, a full area of at least one subarea detected to contain the abnormal transport vehicle.

3. The article transport facility according to claim 1, wherein:
in the abnormality process, in response to the control system not detecting, among the plurality of subareas, one subarea containing the abnormal transport vehicle or a plurality of subareas containing the abnormal transport vehicle across a boundary between the plurality of subareas, the control system sets a different range of the entry prohibited area based on a type of the abnormality in the abnormal transport vehicle.

4. The article transport facility according to claim 1, wherein:
each of the plurality of subareas comprises a position information holder holding position information of the subarea,
each of the plurality of transport vehicles comprises a reader configured to read the position information held by the position information holder,
the abnormality in the transport vehicle comprises a first abnormality caused by the transport vehicle deviating from a stop target position within a range in which the position information holder at the stop target position is readable by the transport vehicle, a second abnormality caused by the transport vehicle deviating from the stop target position by a degree to which the position information holder at the stop target position is unreadable by the transport vehicle, and a third abnormality caused by the transport vehicle colliding with another transport vehicle of the plurality of transport vehicles,
in response to the first abnormality in the abnormal transport vehicle, the control system sets, as the entry prohibited area, a range of L subareas in a forward traveling direction of the abnormal transport vehicle starting from, among the plurality of subareas, a subarea containing the abnormal transport vehicle immediately before having the abnormality, where L is an integer greater than or equal to 2,
in response to the second abnormality in the abnormal transport vehicle, the control system sets, as the entry prohibited area, a range of M×M subareas in the forward traveling direction of the abnormal transport vehicle including the subarea containing the abnormal transport vehicle immediately before having the abnormality, where M is an integer greater than or equal to 2, and
in response to the third abnormality in the abnormal transport vehicle, the control system sets, as the entry prohibited area, a range of N×N subareas centered at the subarea containing the abnormal transport vehicle immediately before having the abnormality, where N is an integer greater than M.
